(19) United States
(12) Patent Application Publication
(10) Pub. No.: US 2024/0083219 A1
(43) Pub. Date: Mar. 14, 2024

(54) AIR TREATMENT UNIT FOR RECREATIONAL VEHICLES

(71) Applicant: Future Air Solutions Tech LLC, South Bend, IN (US)

(72) Inventor: Neil Kelly, Syracuse, IN (US)

(21) Appl. No.: 18/515,678

(22) Filed: Nov. 21, 2023

Related U.S. Application Data
(60) Provisional application No. 63/543,763, filed on Oct. 12, 2023.

(51) Int. Cl. B60H 1/32; B60H 1/00

(52) U.S. Cl. CPC B60H 1/323; B60H 1/00521; B60H 1/3227; B60H 2001/003

(57) ABSTRACT

An exemplary air treatment unit is configured for installation to a recreational vehicle. The air treatment unit generally includes a housing, a power conditioning circuit, a refrigerant loop, and a blower. The housing includes an outlet manifold. The power conditioning circuit is configured to convert alternating current power of a first voltage to direct current power of a second voltage less than the first voltage. The refrigerant loop includes a compressor, a condenser, an expander, and an evaporator. The compressor is configured to operate using the direct current power of the second voltage, and the evaporator is positioned within the housing. The blower is positioned within the housing, and is configured to operate using the direct current power of the second voltage. The blower is configured to charge air through the evaporator toward the outlet manifold.

### CROSS-REFERENCE TO RELATED APPLICATIONS

The present application claims the benefit of U.S. Provisional Patent Application No. 63/543,763, filed Oct. 12, 2023, the contents of which are incorporated by reference in their entirety.

### TECHNICAL FIELD

The present disclosure generally relates to air treatment systems, and more particularly but not exclusively relates to heating, ventilation, and air conditioning (HVAC) systems for mobile compartments, such as that of a recreational vehicle.

### BACKGROUND

Recreational vehicles are often provided with roof-mounted HVAC units. However, it has been found that some such roof-mounted units can come with certain drawbacks and limitations. For example, placing an HVAC unit on the roof of a recreational vehicle increases the height of the vehicle, which leads to the undesirable effect of limiting entry of the vehicle to low-clearance spaces. A roof mounted unit may additionally or alternatively raise the center of gravity of the vehicle, which can lead to tipping hazards. Moreover, the seals around the roof-mounted unit frequently fail, which can lead to leaking of liquid into the cabin. These issues can be exacerbated by the size of the compressors utilized in the systems, as these compressors are typically relatively large and heavy. For these reasons among others, there remains a need for further improvements in this technological field.

### SUMMARY

An exemplary air treatment unit is configured for installation to a recreational vehicle. The air treatment unit generally includes a housing, a power conditioning circuit, a refrigerant loop, and a blower. The housing includes an outlet manifold. The power conditioning circuit is configured to convert alternating current power of a first voltage to direct current power of a second voltage less than the first voltage. The refrigerant loop includes a compressor, a condenser, an expander, and an evaporator. The compressor is configured to operate using the direct current power of the second voltage, and the evaporator is positioned within the housing. The blower is positioned within the housing, and is configured to operate using the direct current power of the second voltage. The blower is configured to charge air through the evaporator toward the outlet manifold. Further embodiments, forms, features, and aspects of the present application shall become apparent from the description and figures provided herewith.

### BRIEF DESCRIPTION OF THE FIGURES

FIG. 1 is a perspective view of a recreational vehicle according to certain embodiments.

FIG. 1a illustrates a roof of the vehicle illustrated in FIG. 1.

FIG. 2 is a perspective view of a roof-mounted HVAC unit according to certain embodiments.

FIG. 3 is a schematic diagram of a power conditioning circuit according to certain embodiments.

FIG. 4 is a schematic block diagram illustrating a power conditioning circuit supplying power to a variety of electronic components.

FIG. 5 is a schematic diagram of a refrigerant loop according to certain embodiments.

FIG. 6 is a schematic floor plan for a recreational vehicle according to certain embodiments.

FIG. 7 is a schematic representation of an air treatment unit according to certain embodiments.

FIG. 8 is a schematic representation of an air treatment unit according to certain embodiments.

FIG. 9 is a perspective view of a travel trailer according to certain embodiments.

FIG. 10 is a perspective view of an HVAC unit according to certain embodiments.

FIG. 11 is a schematic plan view of a recreational vehicle according to certain embodiments.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

As used herein, the term “about” may be used to modify a quantitative representation to permit a particular degree of variation from the designated quantity. In certain forms, the term “about” can permit variation of up to 10%. For example, a description of a power provided with “about 12 VDC” can encompass the range of 10.8 VDC to 13.2 VDC.

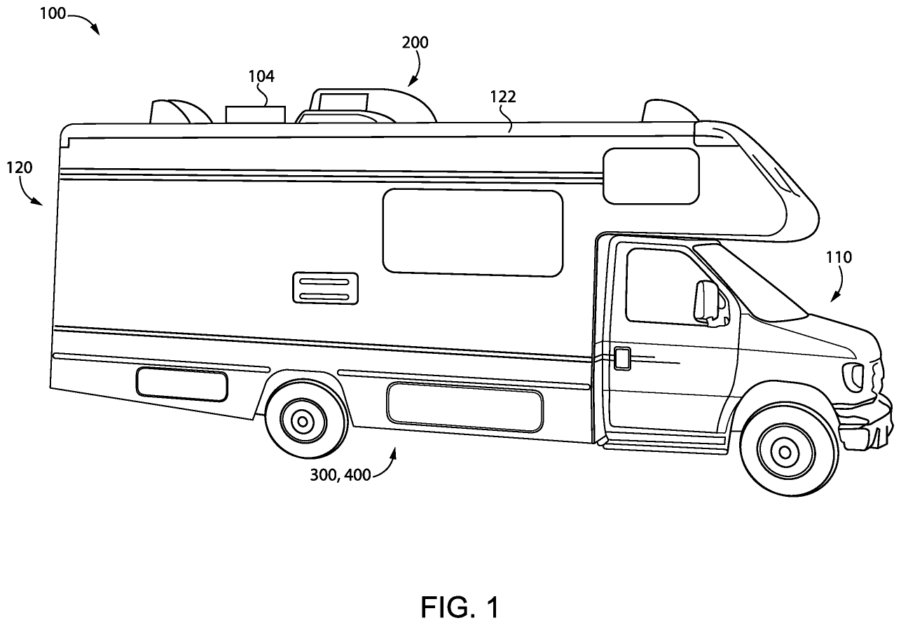

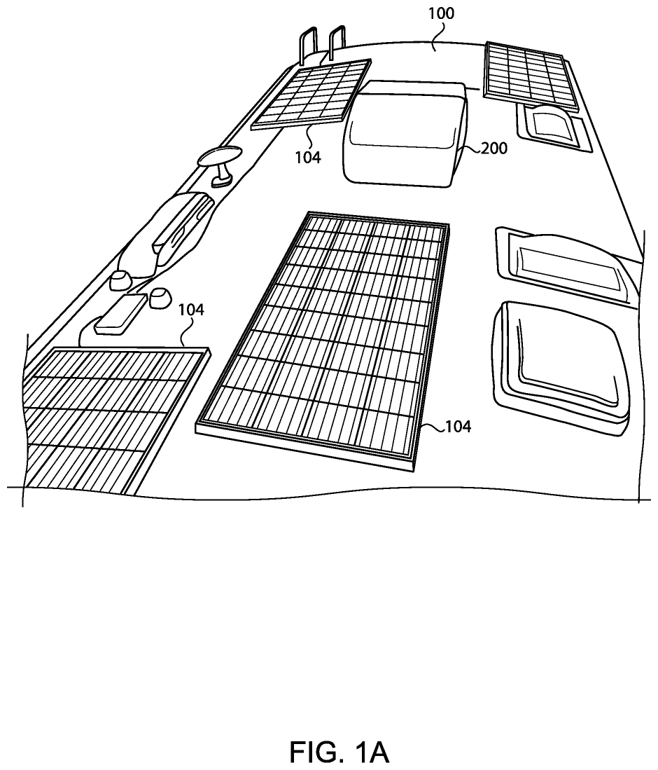

With reference to FIGS. 1 and 1A, illustrated therein is a recreational vehicle 100 according to certain embodiments. The vehicle 100 generally includes a cockpit 110 and a cabin 120, and one or more heating, ventilation, and air conditioning (HVAC) units 200, 300, 400. For example, the vehicle 100 may include a roof-mounted HVAC unit 200 that is mounted to a roof 122 of the cabin 120. In addition or as an alternative to the roof-mounted HVAC unit 200, the vehicle 100 may include an HVAC unit 300 and/or an HVAC unit 400, which may be installed within the cabin 120 and/or below a floor of the cabin 120. While certain embodiments of the present application are described herein with specific reference to a recreational vehicle, it should be appreciated that the concepts described herein may be utilized to provide an HVAC unit to other forms of relatively small enclosures. By way of illustration, the concepts described herein may be utilized in connection with travel trailers, horse trailers, marine vessels, all-terrain vehicles, utility task vehicles, small homes, pop-up establishments, mobile homes, manufactured homes, and/or portable restrooms.

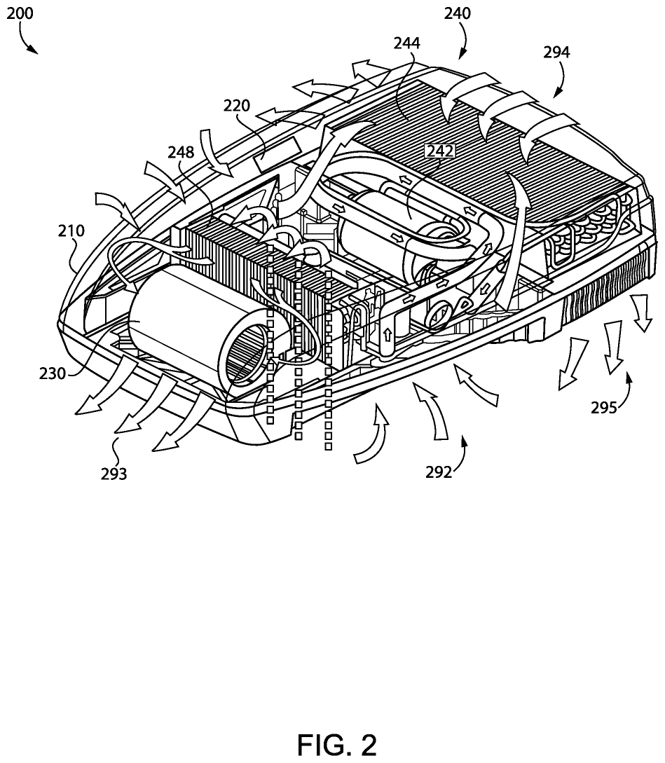

With additional reference to FIG. 2, the HVAC unit 200 generally includes a housing 210, a power conditioning circuit 220 mounted within the housing 210, a blower 230 mounted in the housing 210, and a refrigerant loop 240. The housing 210 provides a mounting location for the working components of the HVAC unit 200, and includes inlets and outlets that permit air to flow through the HVAC unit 200 for the transfer of heat energy between the cabin 120 and the exterior region. While other forms are contemplated, in the illustrated embodiment, the housing 210 is provided in the form of a clamshell housing.

With additional reference to FIG. 3, the power conditioning circuit 220 is configured to convert alternating current of a higher voltage to direct current of a lower voltage (e.g., half or less of the higher voltage). For example, the power conditioning circuit 220 may be configured to convert about 110 volts alternating current (VAC) to a direct current of less than 55 volts, such as about 48 volts direct current (VDC), about 24 VDC, or about 12 VDC. The power conditioning circuit 220 generally includes an input terminal 221 configured for connection to a main power supply 102 of the vehicle 100. While other voltages are contemplated, the main power supply 102 may typically provide power of about 110 volts alternating current (VAC). The power conditioning circuit 220 also includes a rectifier 222 that assists in converting alternating current to direct current, and various electronic components 224 (e.g., resistors, capacitors, and/or diodes) that aid in conditioning the power to the desired voltage (e.g., about 24 VDC), which can be provided to an output terminal 226.

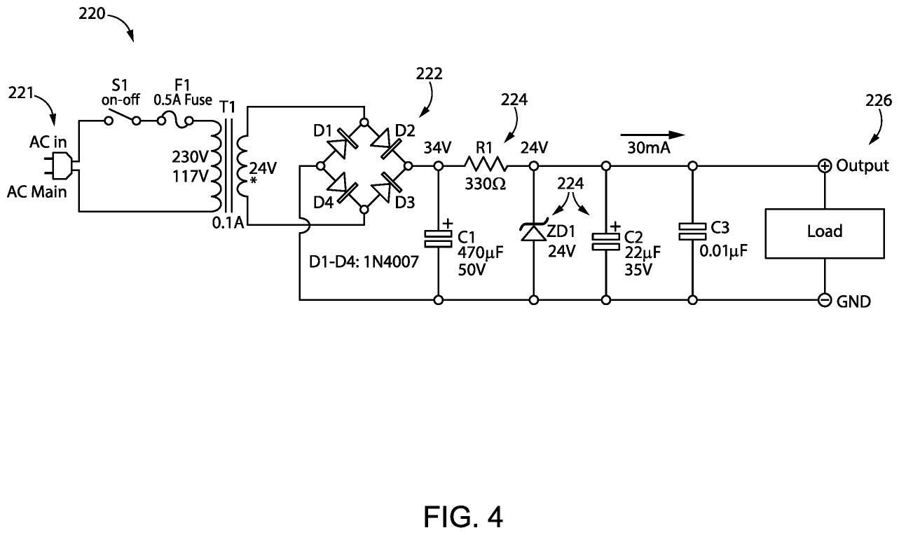

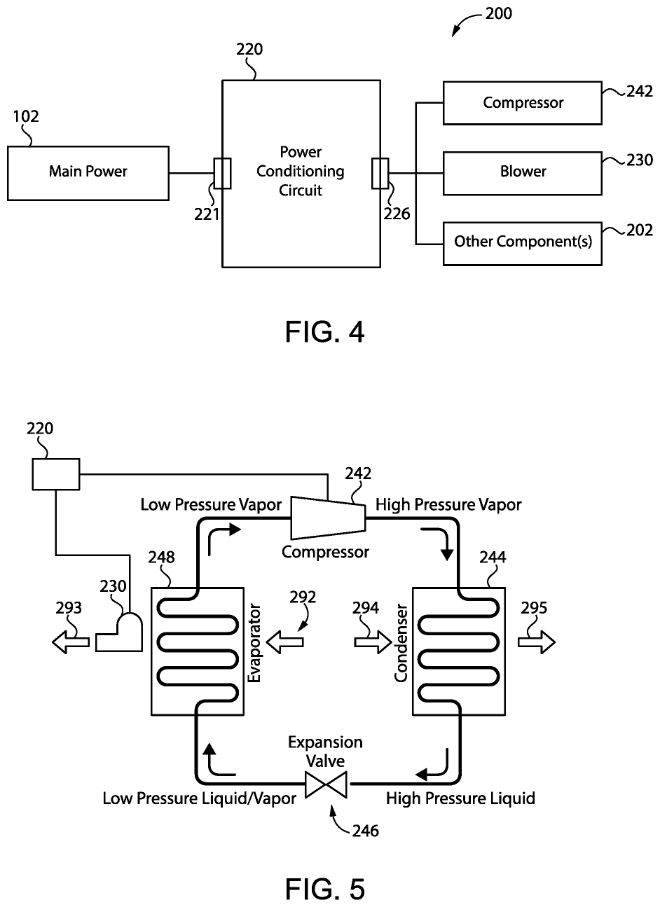

With additional reference to FIG. 4, the power conditioning circuit 220 aids in converting AC power of a first voltage provided by the main power supply 102 to DC power of a second voltage suitable for use by one or more electronic components of the HVAC unit 200. For example, the output terminal 226 may be connected with the blower 230, a compressor 242 of the refrigerant loop 240, and/or one or more other electronic components 202 of the HVAC unit 200. As will be appreciated, the blower 230, the compressor 242, and the other electronic components 202 may be configured to run off of the lower voltage DC power provided by the power conditioning circuit 220. For example, one or more of the components 202, 230, 242 may be configured to run off of 12 VDC power, off of 24 VDC power, or off of 48 VDC power.

With additional reference to FIG. 5, illustrated therein is a schematic representation of the refrigerant loop 240. The refrigerant loop 240 generally includes a compressor 242 that compresses low pressure vapor to a high pressure vapor, a condenser 244 that condenses the high pressure vapor to a high pressure liquid, an expander 246 (e.g., expansion valve, capillary tube, or other form of expander) that expands the high pressure liquid to a low pressure liquid/vapor mixture, and an evaporator 248 that evaporates the low pressure liquid/vapor mixture to a low pressure vapor that is fed to the compressor 242.

As will be appreciated, the refrigerant loop 240 aids in transferring thermal energy between the interior of the cabin 120 and the exterior region. More particularly, a first air supply stream 292 (e.g., from the cabin 120) may be drawn by the blower 230 through the evaporator 248 such that the air supply stream 292 rejects heat energy to the refrigerant, thereby providing a cooler return air stream 293 that is directed back to the cabin 120. Conversely, the condenser 244 may reject heat to a second air supply stream 294 (e.g., from the exterior region) to thereby provide a warmer waste heat stream 295 that is directed to the exterior region.

As noted above, the compressor 242 is configured to run on direct current power of less than 55 VDC. For example, the compressor 242 may be configured to run on about 48 VDC, about 24 VDC, or about 12 VDC. This is in contrast to certain existing systems, which utilize a compressor running on 110 VAC power. Additionally, while the compressors utilized in traditional systems are sealed and cannot be serviced, the compressor 242 is a serviceable model, such as a serviceable electric scroll compressor. In certain embodiments, the compressor 242 may be provided by TCCI Manufacturing of Decatur, Illinois, US. By way of illustration, the compressor 242 may be provided in the form of the TCCI model QPE15-24 or TCCI model QPE24-24. It should be understood, however, that compressors of other models and/or from other manufacturers may be utilized.

Certain existing HVAC units require a 50 amp connection. This requirement can limit the availability of power supplies, for example if a campsite is not equipped with such a 50 amp connection. By contrast, the HVAC units 200, 300, 400 can be configured to run with a lower amperage draw, such as below 10 amp. For example, the HVAC units 200, 300, 400 may be configured to operate in the range of 5 to 7 amp. Lower amperages may, for example, enable the use of solar panels 104 to provide the power to run the HVAC units 200, 300, 400. Lower amperages may additionally or alternatively permit multiple units to be run off of a single power source. For example, if the vehicle 100 is connected to a power supply providing 30 amp of power, a second HVAC unit may run simultaneously with the first HVAC unit to provide additional heating and/or cooling capabilities.

While one form of HVAC unit 200 has been illustrated in connection with the recreational vehicle 100, it should be appreciated that other forms of HVAC units may be so utilized, and that such units may not necessarily be installed to the roof 122. Indeed, it has been found that conventional rooftop mounted units have certain drawbacks, such as those associated with warranty issues. For example, one major avenue for deleterious effects is the sealing provided between a rooftop unit and the cabin roof, which sealing is prone to deterioration that can lead to leaking. Accordingly, certain embodiments of the present application relate to HVAC units that are configured for mounting to the vehicle 100 in a location other than the roof 122, for example as described herein.

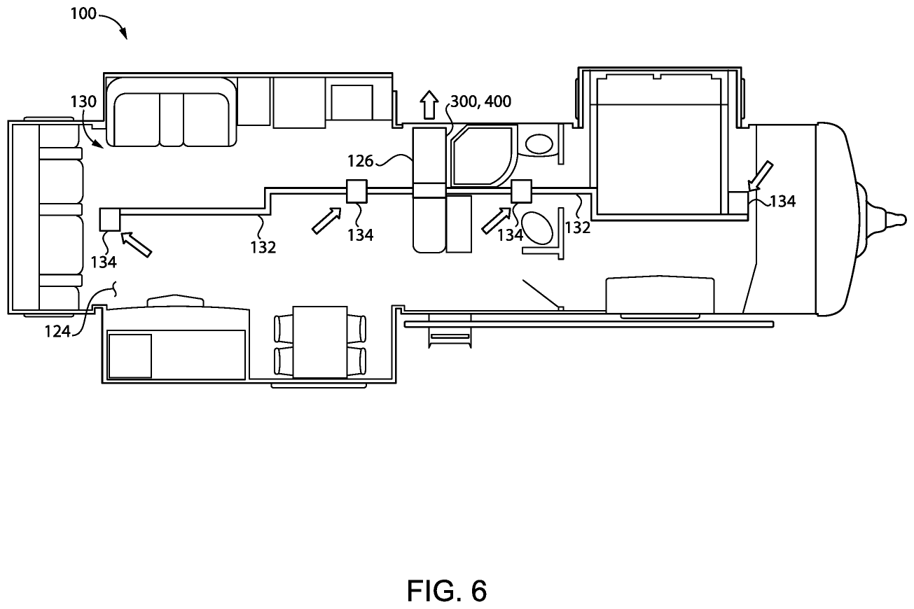

With additional reference to FIG. 6, illustrated therein is an example floorplan for the cabin 120 of the recreational vehicle 100. The cabin 120 has a floor 124, and installed below the floor 124 is a ventilation system 130 that distributes treated air from the HVAC unit 300 and/or the HVAC unit 400 to the cabin 120 via one or more ducts 132 and one or more floor vents 134. In the illustrated embodiment, the HVAC unit 300 and/or the HVAC unit 400 may be installed within a cabinet 126 positioned within the cabin 120. It is also contemplated that the HVAC unit 300 and/or the HVAC unit 400 may be installed in another location, such as below the floor 124. In either case, the HVAC unit may be installed in-line with existing ductwork 132 to thereby utilize the vehicle's existing ventilation system 130 for distribution of treated air.

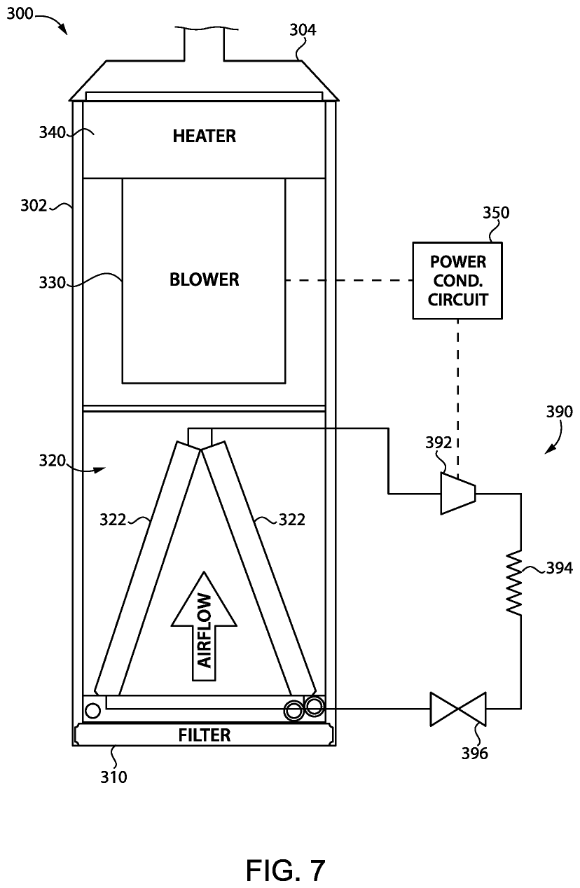

With additional reference to FIG. 7, illustrated therein is a schematic representation of the HVAC unit 300. The HVAC unit 300 generally includes a housing 302, a filter 310 positioned at an intake for the unit 300, an evaporator 320 positioned downstream of the filter 310, a blower 330 positioned downstream of the evaporator 320, and a heater 340 positioned downstream of the blower 330. As will be appreciated, the evaporator 320 constitutes a portion of a refrigerant loop 390 that further includes a compressor 392, a condenser 394, and an expander 396, which function together in a manner substantially similar to that described above with reference to the refrigerant loop 240. In certain forms, the HVAC unit 300 may further include a power conditioning circuit 350 that converts a higher-voltage AC power to a lower-voltage DC power in a manner analogous to that described above with reference to the power conditioning circuit 220. The power conditioning circuit 350 may supply the lower-voltage DC power to the blower 330 and the compressor 392 to thereby power these units.

During a cooling operation, the refrigerant loop 390 and the blower 330 are active, while the heater 340 remains inactive. As such, air is drawn upward through the filter 310 and the coils of the evaporator 320 to thereby filter and cool the air. In the illustrated form, the evaporator 320 is provided in the form of an A-frame evaporator in which two coils 322 are tilted toward one another. While this arrangement has been found to provide good heat transfer characteristics in this application, it should be appreciated that the coils 322 may be provided in another configuration, such as a stacked configuration. After passing through the evaporator 320, the air stream is driven by the blower 330 through the inactive heater 340 to an outlet manifold 304, from which the air stream is distributed to the cabin 120 via the ventilation system 130.

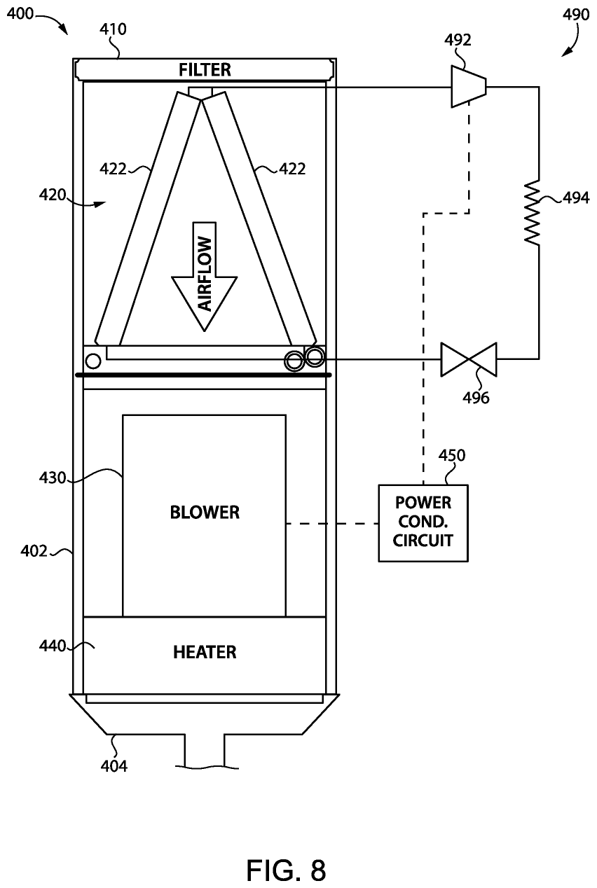

In the form illustrated in FIG. 7, the HVAC unit 300 is provided in an up-flow configuration, in which the filter 310 is positioned below the evaporator 320, and air is driven by the blower 330 through the unit 300 in a generally upward direction to the outlet manifold 304. It is also contemplated that the unit 300 may be arranged in another manner, for example as illustrated in FIG. 8.

With additional reference to FIG. 8, illustrated therein is an HVAC unit 400 according to certain embodiments. The HVAC unit 400 may, for example, be utilized in the vehicle 100 in addition or as an alternative to the HVAC unit 300. The HVAC unit 400 is substantially similar to the HVAC unit 300, and similar reference characters are used to indicate similar elements and features. For example, the HVAC unit 400 generally includes a manifold 404, a filter 410, an evaporator 420, a blower 430, a heater 440, and a power conditioning circuit 450, which respectively correspond to the above-described manifold 304, filter 310, evaporator 320, blower 330, heater 340, and power conditioning circuit 350. The HVAC unit 400 further includes a refrigerant loop 490 that corresponds to the refrigerant loop 390, and which includes a compressor 492, a condenser 494, an expander 496, and the evaporator 420.

In contrast to the above-described up-flow configuration, the HVAC unit 400 is provided in a down-flow configuration, in which the filter 410 is positioned above the evaporator 420, and air is drawn downward by the blower 430 and charged through the manifold 404 positioned below the heater 440. As a result, in this configuration, the air flows generally downward through the housing 402.

In the illustrated form, the recreational vehicle 100 including the HVAC unit 300 and/or the HVAC unit 400 may be provided as an original construction from an original equipment manufacturer. It is also contemplated that an HVAC unit such as the HVAC units 300, 400 may be retrofitted onto an existing recreational vehicle, such as a travel trailer, a fifth wheel, or a motor coach. Moreover, it should be appreciated that various concepts described herein may be utilized outside of the recreational vehicle space, as noted above. For example, one or both of the HVAC units 300, 400 may be installed—either in an original construction or as a retrofit—to treat air for relatively small spaces, such as horse trailers, marine vessels, all-terrain vehicles, utility task vehicles, small homes, pop-up establishments, mobile homes, manufactured homes, and/or portable restrooms.

It should be appreciated that certain embodiments of the HVAC units 300, 400 may present one or more advantages over existing HVAC units for recreational vehicles. By way of example, installing the HVAC units 300, 400 within the cabin 120 and/or below the floor 124 may eliminate the need for ductwork and/or vents in the ceiling of the cabin 120. This arrangement can also eliminate the need for holes in the roof 122 and/or the difficulties associated with the unit draining onto the roof 122. Instead, a low drain point may be utilized such that the drainage can be emptied through the underbelly of the vehicle.

Placing an HVAC unit within the cabin 120 and/or below the floor 124 may at least partially protect the unit from exposure to the elements, such as the sun, wind, precipitation, and extreme temperatures, which protection may increase the expected life of the unit. Elimination of the roof-mounted HVAC unit may permit the vehicle to have a higher roof height and slide box height, which can be important factors, such as in the case of travel trailers. Such elimination may allow for better placement of additional solar panels 104, which may be utilized to run the unit 300/400. Elimination of the roof-top unit also removes several hundred pounds from the roof 122 of the vehicle 100. This will generally lower the center of gravity for the vehicle, which can reduce tipping and rolling risks, particularly in the case of trailer-type vehicles.

In certain embodiments, the refrigerant loop 390 and/or the refrigerant loop 490 may be provided in the form of a heat pump loop. In certain embodiments, the HVAC unit may be provide with a multi-speed recirculation fan to move air more efficiently. In certain embodiments, noise production of the unit may be reduced due to the higher-efficiency components. The units may reduce the risk of freezing of a heat exchanged when inefficient air flow creates a blockage.

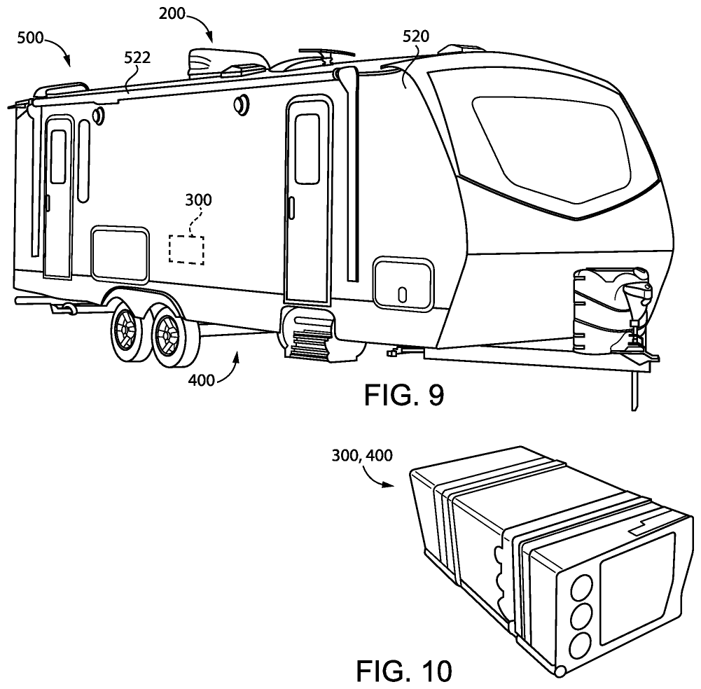

With additional reference to FIG. 9, illustrated therein is another form of recreational vehicle, which is provided in the form of a travel trailer 500. The trailer 500 includes a cabin 520, and may include one or more of the HVAC unit 200, the HVAC unit 300, and/or the HVAC unit 400. For example, the HVAC unit 200 may be installed to the roof 522, the HVAC unit 300 may be installed within a cabinet, and the HVAC unit 400 may be installed below the floor.

With additional reference to FIG. 10, illustrated therein is an embodiment of the HVAC unit 300 and/or the HVAC unit 400. The unit 300/400 may be installed to a cabinet or another secluded location within a cabin of the vehicle 100 and/or the trailer 500, or may be installed below the floor of the vehicle.

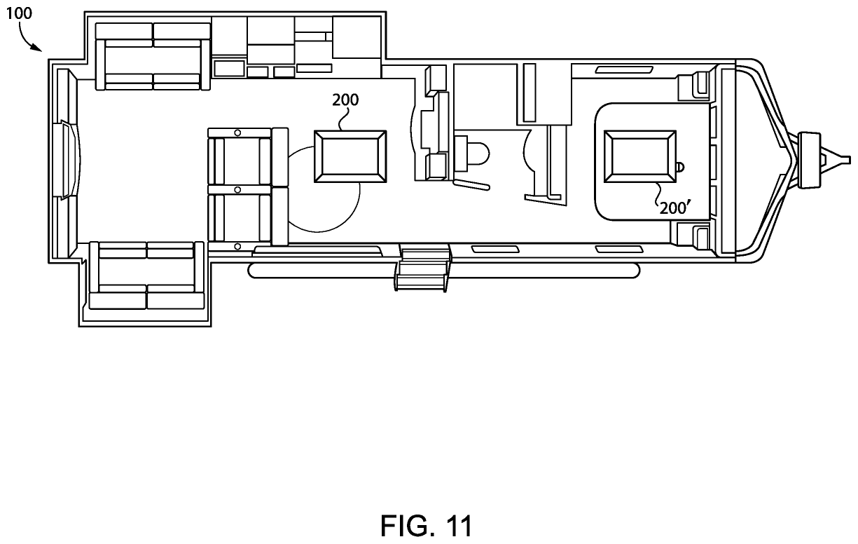

With additional reference to FIG. 11, illustrated therein is the recreational vehicle 100 with the HVAC unit 200 installed to the roof of the vehicle. In the illustrated form, a second HVAC unit 200′ is also installed to the roof, and the units 200, 200′ work together to provide the appropriate conditioning of air for the cabin.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An air treatment unit configured for installation to a recreational vehicle, the air treatment unit comprising:
a housing comprising an outlet manifold;
a power conditioning circuit configured to convert alternating current power of a first voltage to direct current power of a second voltage, wherein the second voltage is less than the first voltage;
a refrigerant loop comprising a compressor, a condenser, an expander, and an evaporator, wherein the compressor is configured to operate using the direct current power of the second voltage, and wherein the evaporator is positioned within the housing; and
a blower positioned within the housing, wherein the blower is configured to operate using the direct current power of the second voltage, and wherein the blower is configured to charge air through the evaporator toward the outlet manifold.

2. The air treatment unit of claim 1, further comprising a heater positioned between the blower and the outlet manifold.

3. The air treatment unit of claim 2, wherein the heater is configured to operate using the direct current power of the second voltage.

4. The air treatment unit of claim 1, wherein the second voltage is less than half the first voltage.

5. The air treatment unit of claim 1, wherein the second voltage is less than 50 volts.

6. The air treatment unit of claim 1, wherein the second voltage is about 12 volts, about 24 volts, or about 48 volts.

7. The air treatment unit of claim 1, wherein the compressor is a serviceable scroll compressor.

8. The air treatment unit of claim 1, wherein the evaporator comprises a pair of coils arranged in an A-frame configuration.

9. The air treatment unit of claim 1, wherein the blower is positioned between the evaporator and the outlet manifold.

10. The air treatment unit of claim 9, wherein the evaporator is positioned below the blower and the outlet manifold is positioned above the blower such that air flows generally upward through the housing.

11. The air treatment unit of claim 9, wherein the evaporator is positioned above the blower and the outlet manifold is positioned below the blower such that air flows generally downward through the housing.

12. The air treatment unit of claim 1, wherein the air treatment unit is configured to run on ten amps of power or less.

13. A recreational vehicle comprising the air treatment unit of claim 1, wherein the air treatment unit is mounted within a cabin of the recreational vehicle.

14. A recreational vehicle comprising the air treatment unit of claim 1, wherein the air treatment unit is mounted below a floor of the recreational vehicle.

15. A recreational vehicle comprising the air treatment unit of claim 1, the recreational vehicle further comprising a ventilation system including at least one floor duct, wherein the ventilation system is configured to direct treated air from the air treatment unit to the at least one floor duct.

16. A method, comprising:
installing the air treatment unit of claim 1 to a recreational vehicle, wherein the installing comprises connecting the outlet manifold to a ventilation system of the recreational vehicle.
